(19) United States
(12) Patent Application Publication
(10) Pub. No.: US 2025/0272944 A1
(43) Pub. Date: Aug. 28, 2025

(54) LEARNING-BASED SEMANTIC SEGMENTATION METHOD AND DEVICE FOR SEMICONDUCTOR METROLOGY

(71) Applicants: SK hynix Inc., Icheon-si (KR); KOREA UNIVERSITY RESEARCH AND BUSINESS FOUNDATION, Seoul (KR)

(72) Inventors: Munki JO, Icheon-si (KR); Kyung Hye KIM, Icheon-si (KR); Heejoong ROH, Icheon-si (KR); Seoung Bum KIM, Seoul (KR); Hansam CHO, Seoul (KR); Insung BAEK, Seoul (KR); Yongwon JO, Seoul (KR); Jinsoo BAE, Seoul (KR); Sungsu KIM, Seoul (KR)

(21) Appl. No.: 19/063,762

(22) Filed: Feb. 26, 2025

(30) Foreign Application Priority Data
Feb. 28, 2024 (KR) 10-2024-0028628

(51) Int. Cl. G06V 10/26; G06V 10/25; G06V 10/34; G06V 10/764; G06V 10/774; G06V 10/82

(52) U.S. Cl. CPC G06V 10/26; G06V 10/25; G06V 10/34; G06V 10/764; G06V 10/774; G06V 10/82

(57) ABSTRACT

A learning-based semantic segmentation method and apparatus for semiconductor metrology are disclosed. The method includes performing, using a processor, a pre-training stage to determine initial weights among nodes within a neural network model by pre-training the neural network for process-specific semantic segmentation; and performing, using a processor, a fine-tuning stage to classify an input wafer TEM or SEM image into at least one object of interest based on pre-trained weights, and to assign a weight (α) greater than one ( ) to pixels corresponding to boundaries separating the objects of interest and a weight one (1) to other pixels corresponding to regions distinct from the boundaries using a loss function (L_{BF}).

### CROSS-REFERENCES TO RELATED APPLICATION

The present application claims, under 35 U.S.C. § 119 (a), the benefit of Korean Patent Application No. 10-2024-0028628, filed on Feb. 28, 2024, which is hereby incorporated by reference in its entirety.

### BACKGROUND

### 1. Field

Embodiments of the present disclosure relate to computer vision technology, and more particularly, to a learning-based semantic segmentation method and device for semiconductor metrology.

### 2. Description of the Related Art

Deep learning technology is increasingly being utilized in a wide range of applications in the semiconductor industry, especially in semiconductor metrology. Semiconductor metrology involves measuring the physical and electrical properties of semiconductor devices during the semiconductor manufacturing process to ensure quality. Minimizing defects and improving yields are critical, as they are directly tied to profitability.

The primary focus of the semiconductor metrology is on wafers, encompassing tasks such as defect classification and defect pattern recognition. These tasks require a holistic understanding of image information rather than focusing on specific details. However, with advancements in nano-scale engineering, precise measurement of micro-patterns within wafer images has become increasingly important. As the size of components or devices inside the wafer shrinks, inspectors often rely on direct observation and detailed measurements of target objects. These manual processes are time-consuming and prone to errors, influenced by the experience of the inspector and the quality of the image. In addition, nano-scale semiconductor devices are tiny, so even minor errors can have significant consequences. As a result, there is a growing demand for artificial intelligence models to automate measurements, reducing human intervention and minimizing errors.

For such automated wafer measurements, imaging techniques such as wafer Scanning Electron Microscope (SEM) and wafer Transmission Electron Microscope (TEM) are commonly used. These imaging techniques use an electron beam, which interacts with a specimen on a wafer, often resulting in scattering or absorption within the specimen on the wafer. This interaction can generate common noise in TEM or SEM images.

Such noise can blur object boundaries and degrade image quality in TEM or SEM images, which may hinder the effective training of artificial intelligence models for automated measurements.

### SUMMARY

The technological objective of the present disclosure is to provide a learning-based semantic segmentation method for automated semiconductor metrology.

In addition, the technological objective of the present disclosure is to provide a learning-based semantic segmentation method for semiconductor metrology that accurately represents ambiguous object boundaries in TEM or SEM images, thereby mitigating image quality degradation.

In addition, the technological objective of the present disclosure is to provide a learning- based semantic segmentation device having the aforementioned advantages.

The objectives addressed by the present disclosure are not limited to those mentioned above. Other objectives may become apparent to those skilled in art from the following description.

According to one embodiment of the present invention, a learning-based semantic segmentation method includes performing, using a processor, a pre-training stage to determine initial weights among nodes within a neural network model by pre-training the neural network model for process-specific semantic segmentation; and performing, using a processor, a fine-tuning stage to classify an input wafer TEM or SEM image into at least one object of interest based on the pre-trained weights, and to assign a weight (α) greater than one (1) to pixels corresponding to boundaries separating the objects of interest and a weight one (1) to other pixels corresponding to regions distinct from the boundaries using a loss function (L_{BF}).

The loss function (L_{BF}) is defined by the following mathematical expression.

$${L}_{BF} = - {\sum }_{c = 0}^{C} {\sum }_{i = 0}^{n} I ( i ) * {y}_{i} * log ( {\hat{y}}_{i , c} )$$

where C denotes a number of object types with backgrounds, I(i) is a function equal to ‘α’ if pixel i is on the boundaries and ‘1’ if pixel i is outside the boundaries, yi denotes an object type of pixel i, and ŷ_{i,c} is a logit of pixel i belonging to an object type c.

The step of fine-tuning stage further comprises extracting the pixels corresponding to the boundaries, wherein the pixels corresponding to the boundaries may be extracted by morphological edge detection.

The semantic segmentation may use any of the DeepLab affiliation, U-Net, PSPNet, SegNet, SegFormer, and Fully Convolutional networks (FCNs) including an encoder-decoder model. The encoder-decoder model may comprise any one of an original autoencoder (AE), a denoising AE (DAE), a context AE, a stacked AE (SAE), a sparse AE (SSAE), a contractive AE (ContAE), a convolutional AE (CAE), and a variational AE (VAE).

The pre-training stage may use a cross-entropy loss function (L_{seg}), which is represented by the following mathematical expression.

$${L}_{seg} = - {\sum }_{p = 0}^{P} {w}_{p} \cdot {\sum }_{j = 0}^{n} {y}_{p , j} \cdot log ( {y}_{p , j} )$$

where p (p=0, 1, . . . , p, where 0 represents background) represents a process index, wₚ represents a weight associated with a process p, n represents a number of pixels in the wafer TEM image, y_{p,j} is an actual class label of pixel j in Ground Truth, and ŷ_{p,j} is predicted probability of the pixel j belonging to process p.

According to one embodiment of the present invention, a device for a learning-based semantic segmentation for semiconductor metrology, comprising: a storage medium configured to store a neural network model for process-specific semantic segmentation; and at least one processor configured to pre-train the neural network model to determine initial weights between nodes within the neural network model, and classify an input wafer TEM or SEM image into at least one object of interest based on pre-trained weights, use a loss function (L_{BF}) to assign a weight (α) greater than one (1) to pixels corresponding to boundaries separating the objects of interest and a weight one (1) to other pixels corresponding to regions distinct from the boundaries.

The loss function (L_{BF}) may be defined by the following mathematical expression.

$${L}_{BF} = - {\sum }_{c = 0}^{C} {\sum }_{i = 0}^{n} I ( i ) * {y}_{i} * log ( {\hat{y}}_{i , c} )$$

where C denotes a number of object types with backgrounds, I(i) is a function that equals ‘α’ if pixel i is on the boundaries and ‘1’if pixel i is outside the boundaries, yi is an object type of pixel i, and ŷ_{i,c} is a logit of pixel i belonging to an object type c.

The processor may extract the pixels corresponding to the boundaries. The pixels corresponding to the boundaries may be extracted by morphological edge detection. The semantic segmentation may use any one of the DeepLab affiliation, U-Net, PSPNet, SegNet, SegFormer, and Fully Convolutional networks (FCNs) comprising an encoder-decoder model, wherein the encoder-decoder model may include any one of an original AE (autoencoder), a denoising AE (DAE), a context AE, a stacked AE (SAE), a sparse AE (SSAE), a contractive AE (ContAE), a convolutional AE (CAE), and a variational AE (VAE).

In addition, the pre-training may use a cross-entropy loss function (L_{seg}), which is represented by the following mathematical expression.

$${L}_{seg} = - {\sum }_{p = 0}^{P} {w}_{p} \cdot {\sum }_{j = 0}^{n} {y}_{p , j} \cdot log ( {y}_{p , j} )$$

where p (p=0, 1, . . . , p, where 0 represents background) represents a process index, wₚ represents a weight associated with a process p, n is a number of pixels in the wafer TEM image, y_{p,j} is an actual class label of pixel j in Ground Truth, and ŷ_{p,j} is predicted probability of the pixel j beloing to the process p.

Embodiments of the present disclosure provide a learning-based semantic segmentation method and apparatus for automated semiconductor metrology. By distinctly and differentially binarizing the weights of boundaries that separate objects of interest in wafer SEM or TEM images from surrounding regions, the method enhances the model's ability to identify boundary information. This improves the model's capacity to accurately recognize object locations and boundaries.

Additionally, the method addresses image quality degradation by effectively representing ambiguous object boundaries in TEM or SEM images.

The effects of the present invention are not limited to the aforementioned effects and may be extended in various ways without departing from the underlying technical concepts and scope of the present invention.

### BRIEF DESCRIPTION OF THE DRAWINGS

FIG. 1 shows wafer TEM images.

FIG. 2 illustrates a learning-based semantic segmentation method for semiconductor metrology, according to one embodiment of the present disclosure.

FIG. 3 shows an example input-target pair of wafer TEM images used for transfer learning according to one embodiment of the present disclosure.

FIG. 4 illustrates a diagram showing an example of weighting pixels corresponding to a boundary that delimits an object of interest, as well as other pixels corresponding to regions distinct from the boundary, according to one embodiment of the present disclosure.

FIG. 5 illustrates a frame structure for implementing a learning-based semantic segmentation method for semiconductor metrology, according to one embodiment of the present disclosure.

FIG. 6 compares the prior art with predicted results of the present disclosure for process-specific input images, according to one embodiment of the present disclosure.

FIG. 7 illustrates the predictive performance of a learning-based semantic segmentation method for semiconductor metrology, according to one embodiment of the present disclosure.

FIG. 8 illustrates a learning-based semantic segmentation device in accordance with one embodiment of the present disclosure.

### DETAILED DESCRIPTION

Hereinafter, the embodiments of the present disclosure will be described in detail with reference to the accompanying drawings.

The embodiments of the present disclosure to be described below are provided to explain the invention more clearly to those having common knowledge in the related art, and the scope of the invention is not limited by the following embodiments. The following embodiments may be modified in many different forms.

The terminology used herein is used to describe specific embodiments, and is not used to limit the invention. As used herein, terms in the singular form may include the plural form unless the context clearly dictates otherwise. Also, as used herein, the terms “comprise” and/or “comprising” specify presence of the stated shape, step, number, action, member, element and/or group thereof; and does not exclude presence or addition of one or more other shapes, steps, numbers, actions, members, elements, and/or groups thereof. In addition, the term “connection” as used herein means not only a concept that certain members are directly connected, but also a concept that other members are further interposed between the members to be indirectly connected.

In addition, in the present specification, when a member is said to be located “on” another member, this includes not only a case in which a member is in contact with another member but also a case in which another member is present between the two members. As used herein, the term “and/or” includes any one and any combination of one or more of those listed items. In addition, as used herein, terms such as “about,” “substantially,” etc. are used as a range of the numerical value or degree, in consideration of inherent manufacturing and material tolerances, or as a meaning close to the range. Furthermore, accurate or absolute numbers provided to aid the understanding of the present application are used to prevent an infringer from using the disclosed present invention unfairly.

Hereinafter, the embodiments of the present disclosure will now be described in detail with reference to the accompanying drawings. The sizes or thicknesses of the areas or parts shown in the accompanying drawings may be somewhat exaggerated for clarity and ease of description. Throughout the detailed description, like reference numerals designate like components.

In the present disclosure, semantic segmentation, an artificial intelligence-based computer vision algorithm, is proposed for automated semiconductor metrology applications. The semantic segmentation can be processed at the pixel level to classify individual pixels and associate them with specific objects. This capability enables the precise identification of the measurement area, which can significantly advance automated metrology.

However, utilizing semantic segmentation for measuring objects of interest in wafer TEM images presents several challenges due to three unique characteristics of the wafer TEM images. The first characteristic is related to the scarcity and limited availability of training data. Unlike classification tasks that utilize the entire image information, the semantic segmentation requires intricate details within the image, necessitating a substantial amount of training data. However, collecting and annotating TEM images involves destructive testing and significant effort by trained experts, making it challenging to compile large datasets for training.

The second characteristic can be caused by the ambiguity of object boundaries. While the semantic segmentation primarily focuses on object areas for automated measurement, the precise identification of object boundaries is often more critical than internal regions, particularly for nano-scale TEM images. Minor inaccuracies in boundary detection can impair the model's learning ability and reduce measurement accuracy.

The third characteristic is the presence of noise in wafer TEM images, caused by image detection devices. Despite the requirement for high-quality images in the semantic segmentation, various types of noise degrade the image quality and interfere with the training and performance of the semantic segmentation model.

The present disclosure proposes a wafer TEM image-specific semantic segmentation and transfer learning framework to solve problems related to semantic segmentation applications. The proposed framework of the present disclosure may include a pre-training stage using images collected from various processes and a fine-tuning stage using a boundary-focused loss function. The pre-training stage may be designed to mitigate the challenges associated with acquiring and annotating wafer TEM images. During the pre-training, TEM images from various manufacturing processes may be fully utilized to develop a segmentation model capable of detecting objects of interest across the entire manufacturing workflow. Following the pre-training, the pre-trained model undergoes fine-tuning for each specific process using a boundary-focused loss function. This fine-tuning stage addresses issues arising from limited training samples, significant noise, and unclear object boundaries. The boundary-focused loss function may play a critical role in accurately identifying object boundaries, thereby enhancing the effectiveness of the automated measurement.

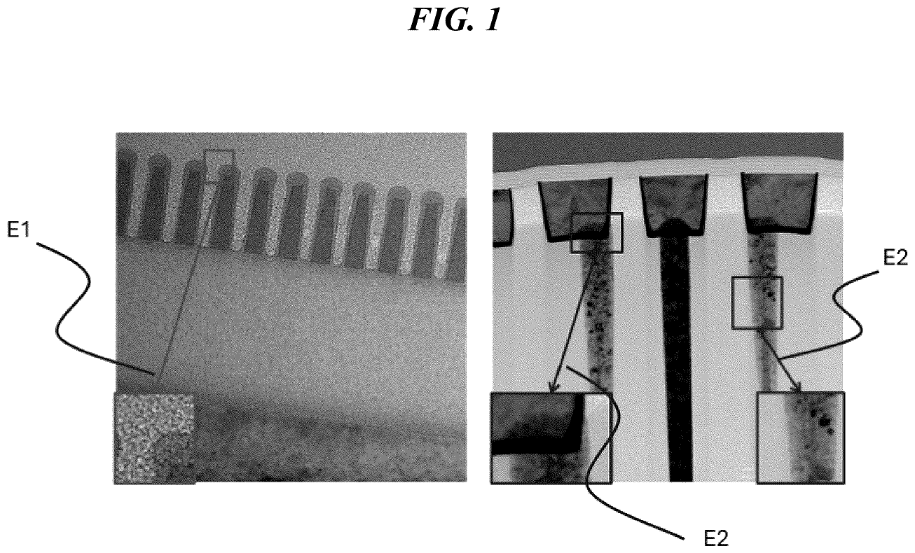

FIG. 1 shows wafer TEM images.

Referring to FIG. 1, a TEM image on the left is a wafer TEM image corresponding to a first process, and a TEM image on the right is a wafer TEM image corresponding to a second process. Noises caused by electron beam scattering or absorption within a specimen on a wafer may appear in the wafer TEM image, as indicated by the first box (E1) and the second box (E2). This noise degrades resolution and blurs the boundaries of objects of interest. The image in the larger rectangle shows a magnified view of the area highlighted in the smaller rectangle.

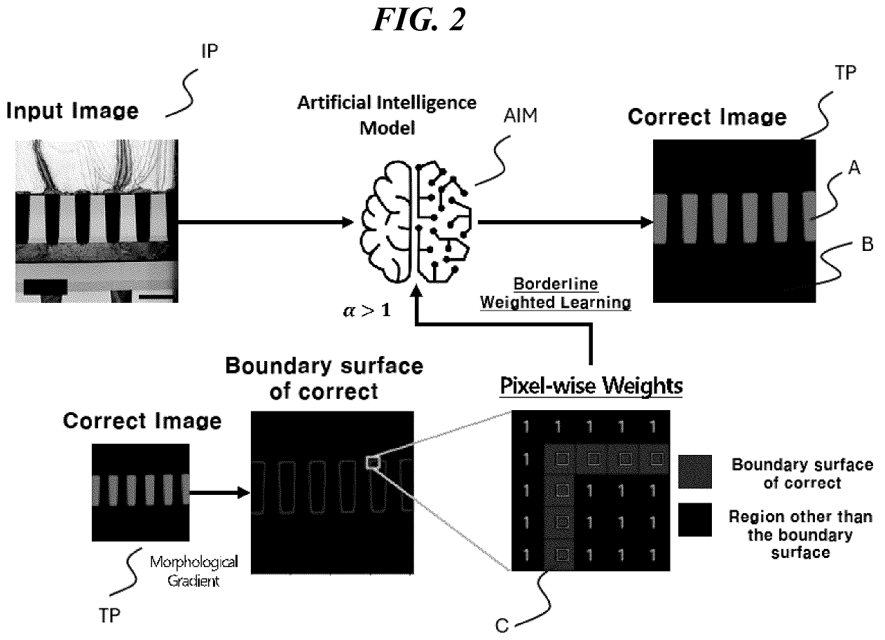

FIG. 2 illustrates a learning-based semantic segmentation method for semiconductor metrology, according to one embodiment of the present disclosure.

Referring to FIG. 2, an artificial intelligence model (AIM) may include, without limitation, a deep learning-based neural network model. The deep learning-based neural network model may include either a convolutional neural network (CNN) structure or a recurrent neural network (RNN) structure. The deep learning-based neural network model may be trained using semantic segmentation models having an encoder-decoder structure. In addition, such a deep learning-based neural network model may operate on a computer system including a storage medium and at least one processor.

In one embodiment, the artificial intelligence model (AIM) may output a correct (or processed) image (TP) corresponding to an input image (IP), where the input image (IP) includes a wafer TEM or SEM image. The correct image (TP) is the result of applying semantic segmentation to the input image (IP). The semantic segmentation classifies each pixel in the input image (IP) into a specific class and modifies the RGB value of the pixel according to its class to generate the correct image (TP). In the present disclosure, the classes may be categorized into at least one object of interest and regions that are not objects of interest. For example, in the correct image (TP), a first region A represents the object of interest, and a second region B represents other regions that are not objects of interest.

In addition, the artificial intelligence model (AIM) may assign a boundary surface C to the object of interest A in the correct image (TP), and apply a weight to the boundary surface C. For example, the boundary surface C of the object of interest A may be applied a weight greater than 1, while other regions, such as the background and the interior regions of the object of interest A, may be applied a weight of 1. This approach is referred to as “borderline weighted learning”. Information about the boundary surface C of the object of interest A may be determined using morphological edge detection. Preferably, a morphological gradient, which calculates the difference between dilation and erosion to outline the object of interest, may be utilized to detect the boundary surface C of the object of interest A.

In one embodiment of the present disclosure, the artificial intelligence model (AIM) may perform transfer learning on the borderline weighted learning, i.e., it may be pre-trained on the borderline weighted learning.

More preferably, the collected wafer TEM images may be used to pre-train a deep learning-based neural network (AIM) model on an encoder-decoder structure, such as a semantic segmentation model. Herein, Xₚ denotes that the wafer TEM image is collected from process p, and yₚ denotes pixel-level labels serving as the ground truth. The ground truth refers to the correct data used as a reference for prediction accuracy. The deep learning-based neural network (AIM) model may use the ground truth to train an encoder-decoder network to identify objects of interest. The training process may use a cross-entropy loss function (L_{seg}), which is expressed in [Equation 1] below. The ground truth represents the original or true value of the data used for training.

$${L}_{seg} = - {\sum }_{p = 0}^{P} {w}_{p} \cdot {\sum }_{j = 0}^{n} {y}_{p , j} \cdot log ( {y}_{p , j} )$$

Herein, p (p=0, 1, . . . , P, where 0 represents the background) represents the process index, wₚ represents a weight associated with a process p, n represents the number of pixels in the wafer TEM image, y_{p,j} is an actual class label of a pixel j in Ground Truth, and ŷ_{p,j} is predicted probability of the pixel j belonging to the process p.

In addition, in a supervised fine-tuning stage, the present disclosure may train a semantic segmentation model capable of identifying process-specific objects of interest at the pixel level, even in the presence of noise and ambiguous boundaries. First, the final layer of the pre-trained model may be replaced with a convolutional layer, followed by the application of softmax activation. The number of output channels in the convolutional layer may correspond to the number of object types of interest. In order to accurately identify the boundaries of the objects of interest, a boundary-focused loss function, which weights the boundaries instead of cross-entropy, may be used in the map refinement stage. The present disclosure utilizes a morphological edge detection algorithm to define the boundary of the object of interest in the ground truth. The loss function for map refinement (L_{BF}) is expressed in [Equation 2] below.

$${L}_{BF} = - {\sum }_{c = 0}^{C} {\sum }_{i = 0}^{n} I ( i ) * {y}_{i} * log ( {\hat{y}}_{i , c} ) \qquad [ Equation 2 ]$$

Hererin, C denotes the number of object types, including backgrounds, I(i) is a function that equals ‘α’ if pixel i is on the boundary and ‘1’ if pixel i is outside the boundary, yᵢ represents the object type of pixel i, and ŷ_{i,c} is the logit of pixel i belonging to object type c. For example, α=2 indicates that the boundary region is weighted twice as heavily, while α=1 corresponds to the traditional cross-entropy loss. In other words, setting α to 1 applies no additional weight to the boundary region.

As described above, the wafer TEM image-specific semantic segmentation and transfer learning framework of the present disclosure may address the problems associated with the difficulty of wafer TEM image acquisition and the unclear boundaries of objects of interest caused by generalized noise.

In addition, the present disclosure may alleviate the difficulty of TEM image acquisition by pre-training the model with an encoder-decoder architecture using wafer TEM images collected from various manufacturing processes. Furthermore, the transfer learning framework may enhance the accuracy and stability of process-specific segmentation models compared to models that lack pre-training.

In addition, by employing a semantic segmentation model with a loss function (L_{BF}) for map fine-tuning, the proposed disclosure enables clear recognition of objects of interest and boundaries, even in cases of ambiguous boundaries, with limited TEM images. This approach allows for accurate separation of objects of interest, even in complex background environments.

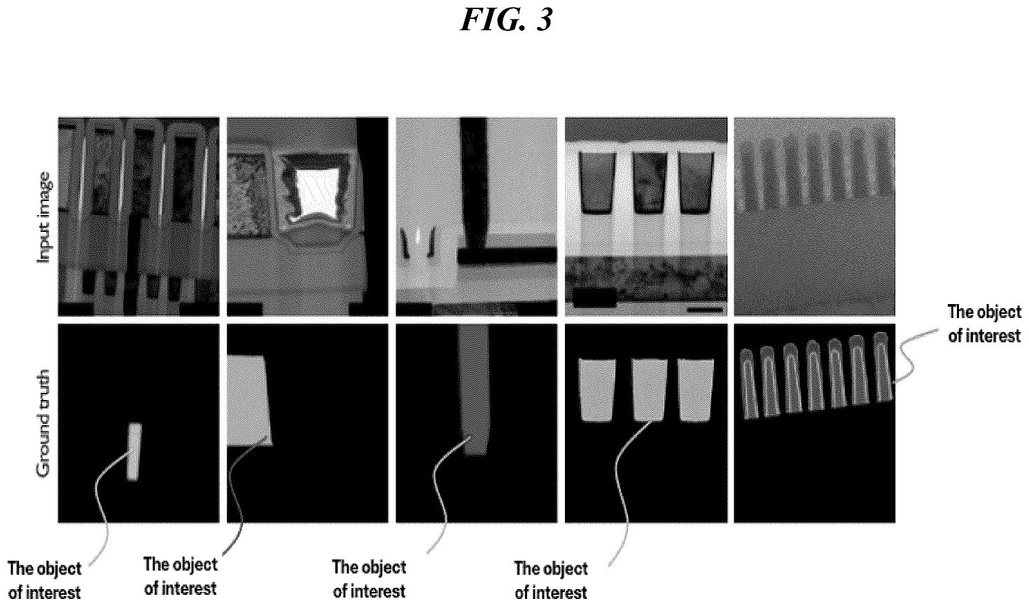

FIG. 3 shows an example input-target pair of wafer TEM images used for transfer learning according to one embodiment of the present disclosure.

Referring to FIG. 3, the first row visualizes input images (PIs) and the second row visualizes the corresponding target ground truth. The images in the second row represent the transformed input images based on the semantic segmentation model, which distinguishes objects of interest from non-interesting regions. The five input images (PIs) in the first row are wafer TEM images, collected from different processes. These input-target pairs of wafer TEM images may be stored in a storage medium as a training dataset for pre-training.

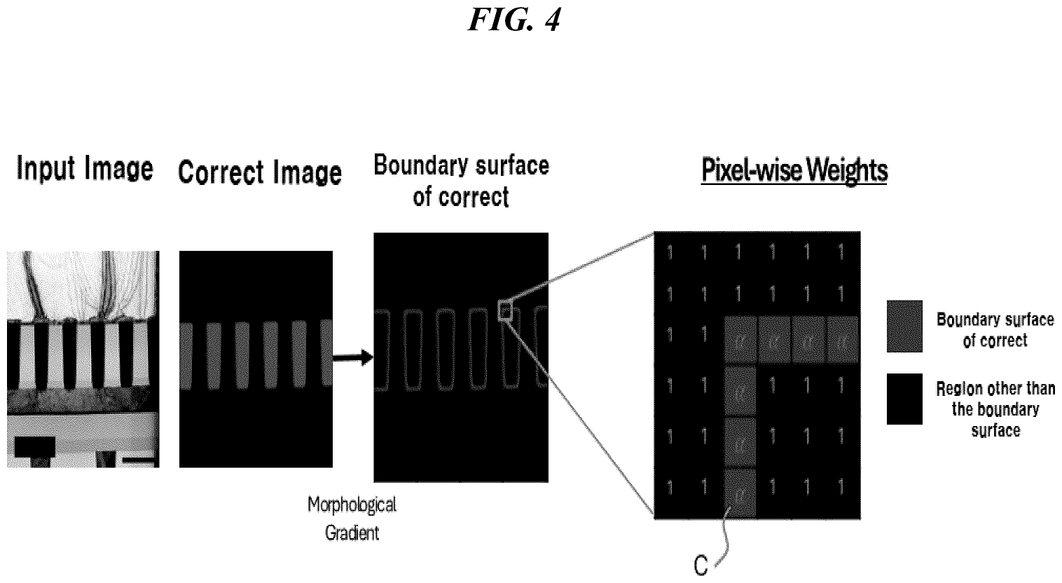

FIG. 4 illustrates an example of weighting pixels corresponding to a boundary that delimits an object of interest, as well as other pixels corresponding to regions distinct from the boundary, according to one embodiment of the present invention.

Referring to FIG. 4, the artificial intelligence model (AIM) may generate a correct image for an input image through pre-training or direct training. The correct image represents a transformed version of the input image, processed using a semantic segmentation model.

In addition, the artificial intelligence model (AIM) may identify the object of interest or its boundary surface (C) from the correct image and assign weights to differentiate between the boundary surface (C) and other regions that are not the boundary surface (C). Specifically, during a refinement stage, a loss function (L_{BF}) may assign a weight (α) greater than 1 to pixels corresponding to the boundary surface (C) separating the object of interest, while assigning a weight of 1 to pixels corresponding to regions distinct from the boundary surface (C). The boundary surface (C) of the object of interest may be determined using morphological edge detection, preferably a morphological gradient, which identifies the outline of the object of interest by calculating the difference between dilation and erosion. By binarizing and distinguishing the boundary of the object of interest from other regions in the correct image, the model may more accurately recognize the boundary of the object of interest.

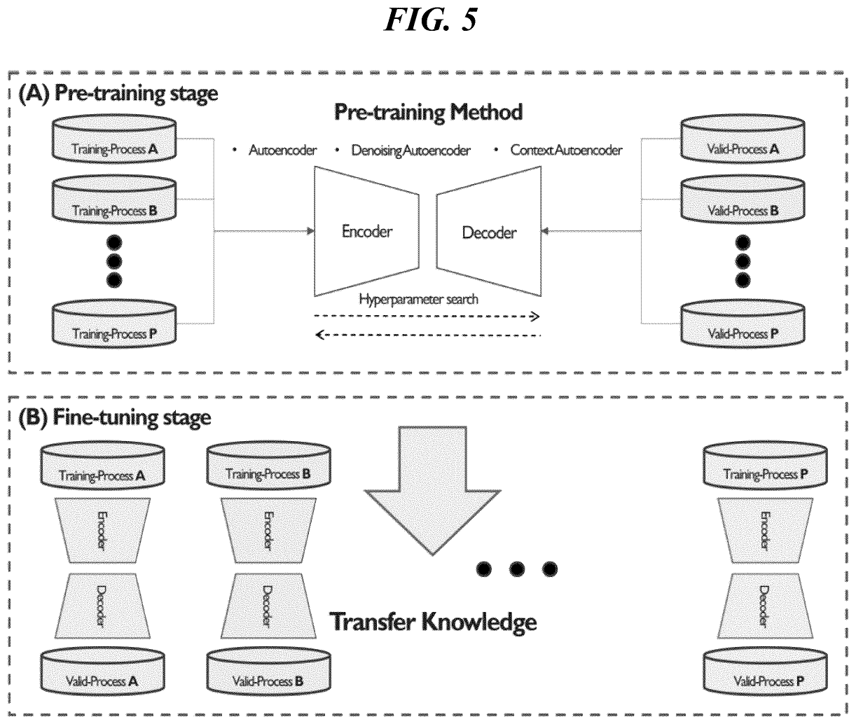

FIG. 5 illustrates a frame structure for implementing a learning-based semantic segmentation method for semiconductor metrology, according to one embodiment of the present disclosure.

Referring to FIG. 5, the frame structure may include a pre-training stage and a fine-tuning stage.

In the pre-training stage, a training dataset is constructed to recognize objects of interest in wafer TEM images for semiconductor metrology. The training dataset may be utilized to generate correct images for the wafer TEM images collected from various manufacturing processes.

Specifically, in the pre-training stage, an encoder-decoder architectural model incorporating an autoencoder (AE) may be trained. The encoder of the encoder-decoder architectural model compresses input data, including a wafer TEM image, to extract features from the input data, and the decoder of the encoder-decoder architectural model reconstructs the input data from the extracted features of the input image. Non-limitingly, the encoder-decoder architectural model may include any of the following: an original autoencoder (AE), a denoising autoencoder (DAE), a context autoencoder, a stacked autoencoder (SAE), a sparse autoencoder (SSAE), a contractive autoencoder (ContAE), a convolutional autoencoder (CAE), and a variational autoencoder (VAE). The pre-trained weights obtained from the pre-training stage can facilitate object recognition across different manufacturing process. Additionally, these weights may serve as useful initial weights when training a segmentation model with a limited number of TEM images for specific processes.

In the fine-tuning stage, the process-specific semantic segmentation model may be refined using the pre-trained weights as initial weights. To enhance the recognition of objects of interest with ambiguous boundaries, the process-specific semantic segmentation model may be trained using a loss function that assigns a weight α greater than 1 to the boundary regions, as described in FIG. 4. The loss function for map refinement (L_{BF}) may be expressed in [Equation 2]. The process-specific semantic segmentation model may incorporate architectures such as DeepLab affiliation, U-Net, PSPNet, SegNet, SegFormer, or Fully Convolutional networks (FCNs) including encoder-decoder models.

### Experiments

### Data Acquisition and Experimental Configuration

In this invention, wafer TEM images were collected from three manufacturing systems at SK hynix, a globally recognized semiconductor manufacturer. The number of TEM images and the number of object types of interest for each process are summarized in Table 1 below. Each TEM image originally had a resolution of 2,048×2,048 pixels, but for analysis, these images were resized to 512×512 pixels.

TABLE 1

| Process | # of types of interesting objects | # of images |
|---|---|---|
| A | 2 (Object or Background) | 121 |
| B | 2 (Object or Background) | 108 |
| C | 3 (Object 1, Object 2, or Background) | 63 |

Referring to [Table 1], the dataset includes 121 wafer TEM images from process A, each containing 2 types of objects of interest, 108 wafer TEM images from process B, each containing 2 types of objects of interest, and 63 wafer TEM images from process C, each containing 3 types of objects of interest.

To train the model, the TEM images produced by the individual processes summarized in Table 1 were split into training, validation, and test datasets, with the following proportions: 80% for training, 10% for validation, and 10% for testing. In the pre-training stage, the Autoencoder (AE) was initialized using Xavier initialization. The training in this stage used the following settings: a batch size of 8, a learning rate of 0.001, a weight decay of 0.01, and 50 epochs, using the AdamW optimizer. The fine-tuning stage included 200 epochs, using the same hyperparameters as the pre-training stage. Data augmentations techniques applied during training included: vertical flip, horizontal flip, and rotation. Finally, a weight of α=2 was assigned to the boundary of the object of interest in the loss function to emphasize boundary recognition.

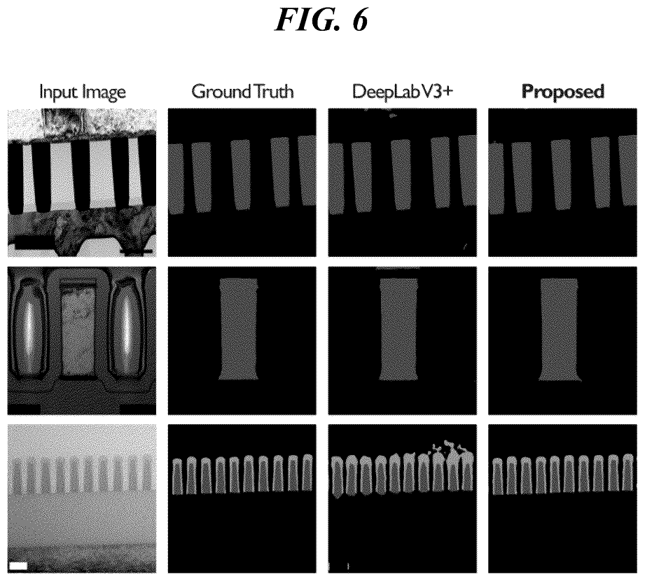

FIG. 6 compares the prior art with the predicted results of the present invention for process-specific input images, according to one embodiment of the present disclosure.

Referring to FIG. 6, the first column presents wafer TEM images acquired from different processes, such as first to third processes A to C The second column (Ground Truth) presents true images obtained by transforming the input images through semantic segmentation. The third column (DeepLabV3+) presents comparison images generated using conventional DeepLabV3+semantic segmentation techniques. Finally, the fourth column (Proposed) illustrates the predicted images produced by the method of the present invention, where the input images have been transformed based on the framework described in FIG. 4.

When comparing the ground truth of the first-row input image obtained from process A with the result from conventional DeepLabV3+, it is evident that noise appears in in the background outside the object of interest. However, when comparing the ground truth of the first-row input image with the predicted image generated by the proposed method, the background contains significantly less noise compared to the result from DeepLabV3+, indicating improved segmentation accuracy.

Similarly, when comparing the ground truth of the second-row input image obtained from process B with the result from conventional DeepLab V3+, it is evident that the background region, excluding the object of interest, appears noise. However, when comparing the ground truth of the second-row input image with the predicted image generated by the proposed method, the background contains less nose compared to the result from DeepLabV3+, demonstrating improved segmentation performance.

When comparing the ground truth of the third-row input image obtained from process C with the result from conventional DeepLabV3+, it is evident that the background region, excluding the object of interest, includes noise, and the boundary of the object of interest appears ambiguous due to noise. However, when comparing the ground truth of the third-row input image with the predicted image generated by the proposed method, it is evident that the boundary of the object of interest closely resembles the ground truth, with less noise than the result from DeepLabV3+, demonstrating improved boundary clarity.

The comparison results demonstrate that the framework of the present disclosure recognizes objects of interest more accurately than the conventional DeepLabV3+, effectively reducing background noise and improving boundary clarity.

### Result

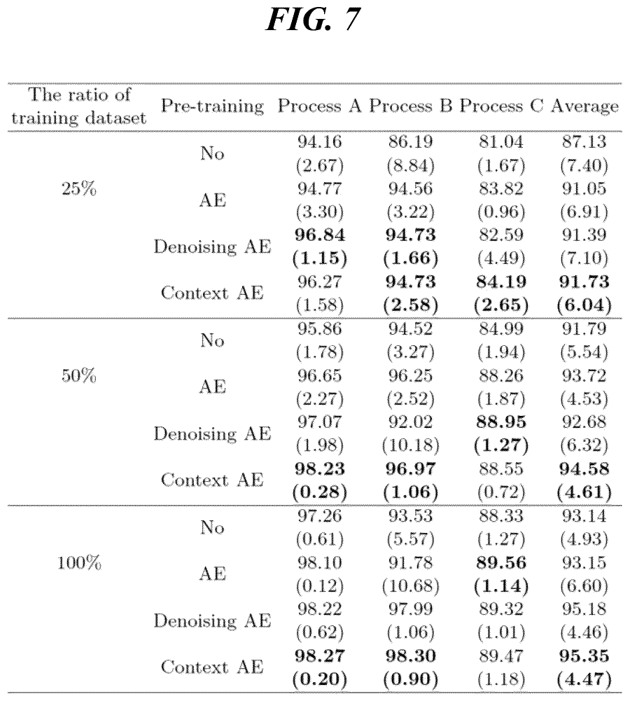

To evaluate the efficiency of the framework of the present invention with a limited number of training TEM images, an experimental setup was established in which the framework was trained using various proportions of the training dataset (e.g., 25%, 50%, and 100%). In the present disclosure, the framework's performance was assessed using the Mean Intersection over Union (MIoU), a metric that qualifies the overlap between the predicted region and the ground truth. Both the framework and the comparison embodiment were trained three times, and the mean and standard deviation of the resulting metrics were recorded. The results are shown in FIG. 7.

FIG. 7 illustrates the predictive performance of a learning-based semantic segmentation method for semiconductor metrology, according to one embodiment of the present disclosure.

Referring to FIG. 7, the score of ‘No pre-training (No)’ represents the performance of the model (DeepLab V3+) in the simple comparison embodiment, which does not utilize pre-training and lossy weights. It is observed that the framework of the present invention outperforms the simple model across all scenarios. In addition, the Context AE pre-training method is found to be the most effective for TEM images. In particular, the performance gap between the comparison embodiment and the framework of the present invention is significantly larger in the 25% training scenario than in the 100% training scenario. Furthermore, the framework trained with the Context AE pre-training method exhibits the lowest standard deviation, indicating that the proposed framework is capable of training robust semantic segmentation models with high performance.

As mentioned earlier, semantic segmentation deep learning models for automated metrology can be effective. However, their effectiveness is hampered by the difficulty of acquiring sufficient wafer TEM images and the significant noise generated by the electron beam, which blurs object boundaries. To address these challenges, the present invention proposes a transfer learning-based semantic segmentation framework. By utilizing transfer learning, the present invention can mitigate the issue of data sparsity across various manufacturing processes.

In addition, a loss function is used to assign greater weight to the boundaries, thereby improving the accuracy of boundary recognition. Experiments conducted in various scenarios using limited TEM images have experimentally demonstrated that the framework of the present invention is more efficient than simple semantic segmentation models that do not utilize transfer learning.

In addition, the present invention introduces a boundary-weighted learning technique suitable for wafer TEM images. This technique enables the artificial intelligence model to more accurately recognize the boundary of the object of interest, thereby improving the region-of-interest prediction performance.

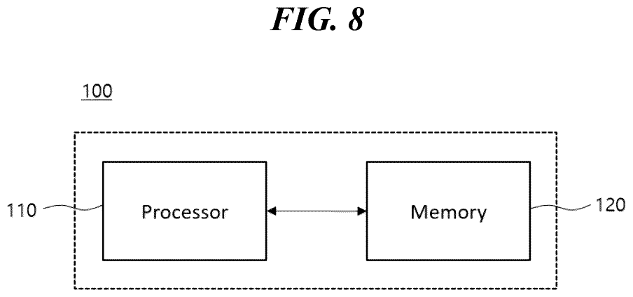

FIG. 8 illustrates a learning-based semantic segmentation device 100, which includes a processor 110 and a memory 120 as a storage medium. The learning-based semantic segmentation method described with reference to FIGS. 2 to 5 may be performed by the device 100. The processor 110 may be a processing unit and can include at least one processor. The memory 120 may store one or more instructions, which the processor 110 executes to perform the learning-based semantic segmentation method for semiconductor metrology. This method includes both the pre-training state and the fine-tuning stage.

This description discloses preferred embodiments of the present invention, and although certain terms are used, they are used in a general sense only to facilitate the description and understanding of the invention and are not intended to limit the scope of the invention. In addition to the embodiments disclosed herein, other modifications based on the technical ideas of the present invention will be apparent to those of ordinary skill in the art to which the present invention belongs. One having ordinary skill in the art will recognize that the learning-based semantic segmentation method and apparatus for semiconductor metrology according to the embodiments described with reference to FIGS. 1 through 5, may be subject to various substitutions, changes, and modifications without departing from the technical ideas of the invention. The scope of the invention is therefore not limited by the embodiments described, but rather by the technical ideas recited in the patent claims.

What is claimed is:

1. A computer-implemented method of a learning-based semantic segmentation for semiconductor metrology, the method comprising:
performing, using a processor, a pre-training stage to determine initial weights among nodes within a neural network model by pre-training the neural network model for process-specific semantic segmentation; and
performing, using a processor, a fine-tuning stage to classify an input wafer TEM or SEM image into at least one object of interest based on pre-trained weights, and to assign a weight (α) greater than one (1) to pixels corresponding to boundaries separating the objects of interest and a weight one (1) to other pixels corresponding to regions distinct from the boundaries using a loss function (L_{BF}).

2. The computer-implemented method of claim 1, wherein the loss function (L_{BF}) is defined by the following mathematical expression:
$${L}_{BF} = - {\sum }_{c = 0}^{C} {\sum }_{i = 0}^{n} I ( i ) * {y}_{i} * log ( {\hat{y}}_{i , c} )$$
where C denotes a number of object types with backgrounds, I(i) is a function equal to ‘α’ if pixel i is on the boundaries and ‘1’ if pixel i is outside the boundaries, yᵢ denotes an object type of pixel i, and ŷ_{i,c} is a logit of pixel i belonging to an object type c.

3. The computer-implemented method of claim 1, wherein the fine-tuning stage further comprises extracting the pixels corresponding to the boundaries.

4. The computer-implemented method of claim 3, wherein the pixels corresponding to the boundaries are extracted by morphological edge detection.

5. The computer-implemented method of claim 1, wherein the semantic segmentation uses any one of DeepLab affiliation, U-Net, PSPNet, SegNet, SegFormer, and Fully Convolutional networks (FCN) including an encoder-decoder model.

6. The computer-implemented method of claim 5, wherein the encoder-decoder model includes any of an original autoencoder (AE), a denoising AE (DAE), a context AE, a stacked AE (SAE), a sparse AE (SSAE), a contractive AE (ContAE), a convolutional AE (CAE), and a variational AE (VAE).

7. The computer-implemented method of claim 1, wherein the pre-training stage uses a cross-entropy loss function (L_{seg}) expressed in the following mathematical expression:
$${L}_{seg} = - {\sum }_{p = 0}^{P} {w}_{p} \cdot {\sum }_{j = 0}^{n} {y}_{p , j} \cdot log ( {y}_{p , j} )$$
where p (p=0, 1, . . . , P, where 0 represents background) represents a process index, wₚ represents a weight associated with a process p, n represents a number of pixels in the wafer TEM image, y_{p,j} is an actual class label of pixel j in Ground Truth, and ŷ_{p,j} is predicted probability of the pixel j belonging to the process p.

8. A device for a learning-based semantic segmentation for semiconductor metrology, the device comprising:
a storage medium configured to store a neural network model for process-specific semantic segmentation; and
at least one processor configured to pre-train the neural network model to determine initial weights between nodes within the neural network model, and classify an input wafer TEM or SEM image into at least one object of interest based on pre-trained weights, use a loss function (L_{BF}) to assign a weight (α) greater than one (1) to pixels corresponding to boundaries separating the objects of interest and a weight one (1) to other pixels corresponding to regions distinct from the boundaries.

9. The device of claim 8, wherein the loss function (L_{BF}) is defined by the following mathematical expression:
$${L}_{BF} = - {\sum }_{c = 0}^{C} {\sum }_{i = 0}^{n} I ( i ) * {y}_{i} * log ( {\hat{y}}_{i , c} )$$
where C denotes a number of object types with backgrounds, I(i) is a function that equals ‘α’ if pixel i is on the boundaries and ‘1’ if pixel i is outside the boundary, yi is an object type of pixel i, and ŷ_{i,c} is a logit of pixel i belonging to an object type c.

10. The device of claim 8, wherein the processor extracts the pixels corresponding to the boundaries.

11. The device of claim 10, wherein the pixels corresponding to the boundaries are extracted by morphological edge detection.

12. The device of claim 8, wherein the semantic segmentation uses any one of DeepLab affiliation, U-Net, PSPNet, SegNet, SegFormer, and Fully Convolutional networks (FCN) including an encoder-decoder model.

13. The device of claim 12, wherein the encoder-decoder model includes any one of an original autoencoder (AE), a denoising AE (DAE), a context AE, a stacked AE (SAE), a sparse AE (SSAE), a contractive AE (ContAE), a convolutional AE (CAE), and a variational AE (VAE).

14. The device of claim 8, wherein the pre-training uses a cross-entropy loss function (L_{seg}) represented by the following mathematical expression:
$${L}_{seg} = - {\sum }_{p = 0}^{P} {w}_{p} \cdot {\sum }_{j = 0}^{n} {y}_{p , j} \cdot log ( {y}_{p , j} )$$
where p (p=0, 1, . . . , P, where 0 represents background) represents a process index, wₚ represents a weight associated with a process p, n is a number of pixels in the wafer TEM image, y_{p,j} is an actual class label of pixel j in Ground Truth, and ŷ_{p,j} is predicted probability of the pixel j belonging to the process p.
